(19) United States
(12) Patent Application Publication
(10) Pub. No.: US 2026/0023942 A1
(43) Pub. Date: Jan. 22, 2026

(54) METHOD AND APPARATUS FOR RESOURCE UTILIZATION OF ACCESS PROCEDURE IN A WIRELESS COMMUNICATION SYSTEM

(71) Applicant: ASUS Technology Licensing Inc., Taipei City (TW)

(72) Inventors: Ming-Che Li, Taipei City (TW); Yi-Hsuan Huang, Taipei City (TW); Meng-Hui Ou, Taipei City (TW); Yu-Hsuan Guo, Taipei City (TW); Wei-Han Lai, Taipei City (TW)

(21) Appl. No.: 19/268,795

(22) Filed: Jul. 14, 2025

Related U.S. Application Data
(60) Provisional application No. 63/673,117, filed on Jul. 18, 2024.

(51) Int. Cl. G06K 7/10; H04W 68/02

(52) U.S. Cl. CPC G06K 7/10069; H04W 68/02

(57) ABSTRACT

Methods, systems, and apparatuses are provided for resource utilization of access procedures in a wireless communication system, wherein a method for a first device comprises receiving a first Reader-to-Device (R2D) message for paging at least the first device, transmitting a first Device-to-Reader (D2R) message based on a first frequency shift, wherein the first D2R message comprises a first Identification (ID) generated by the first device, receiving a second R2D message indicating a set of IDs comprising at least the first ID, and transmitting a second D2R message based on a second frequency shift when the second R2D message indicates information associated with a set of frequency shifts, wherein the second frequency shift is determined, among the set of frequency shifts, based on at least an order of the first ID among the set of IDs.

### CROSS-REFERENCE TO RELATED APPLICATIONS

The present Application claims priority to and the benefit of U.S. Provisional Patent Application Ser. No. 63/673,117, filed Jul. 18, 2024, which is hereby fully incorporated herein by reference.

### FIELD

This disclosure generally relates to wireless communication networks and, more particularly, to a method and apparatus for resource utilization of access procedures in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure is an Evolved Universal Terrestrial Radio Access Network (E-UTRAN). The E-UTRAN system can provide high data throughput in order to realize the above-noted voice over IP and multimedia services. A new radio technology for the next generation (e.g., 5G) is currently being discussed by the 3GPP standards organization. Accordingly, changes to the current body of 3GPP standard are currently being submitted and considered to evolve and finalize the 3GPP standard.

### SUMMARY

Methods, systems, and apparatuses are provided for resource utilization of access procedures in a wireless communication system, to handle Device-to-Reader (D2R) resource(s) allocation and resource(s) determination in access and inventory procedures. As such, signaling overhead and latency for D2R (e.g., Msg3) resource(s) scheduling is reduced.

In various embodiments, a method for a first device in a wireless communication system comprises receiving a first Reader-to-Device (R2D) message for paging at least the first device, transmitting a first D2R message based on a first frequency shift, wherein the first D2R message comprises a first Identification (ID) generated by the first device, receiving a second R2D message indicating a set of IDs comprising at least the first ID, and transmitting a second D2R message based on a second frequency shift when the second R2D message indicates information associated with a set of frequency shifts, wherein the second frequency shift is determined, among the set of frequency shifts, based on at least an order of the first ID among the set of IDs.

In various embodiments, a method for a reader in a wireless communication system comprises transmitting a first R2D message for paging at least a first device, receiving a first D2R message based on a first frequency shift, wherein the first D2R message comprises a first ID generated by the first device, transmitting a second R2D message indicating a set of IDs comprising at least the first ID, and receiving a second D2R message, from the first device, based on a second frequency shift when the second R2D message indicates information associated with a set of frequency shifts, wherein the second frequency shift is determined, among the set of frequency shifts, based on at least an order of the first ID among the set of IDs

### BRIEF DESCRIPTION OF THE DRAWINGS

FIG. 1 shows a diagram of a wireless communication system, in accordance with embodiments of the present invention.

FIG. 2 is a block diagram of a transmitter system (also known as access network) and a receiver system (also known as user equipment or UE), in accordance with embodiments of the present invention.

FIG. 3 is a functional block diagram of a communication system, in accordance with embodiments of the present invention.

FIG. 4 is a functional block diagram of the program code of FIG. 3, in accordance with embodiments of the present invention.

FIG. 5 is a reproduction of FIG. 5: Multiple UEs inventoried in the same slot, from R1-2404459.

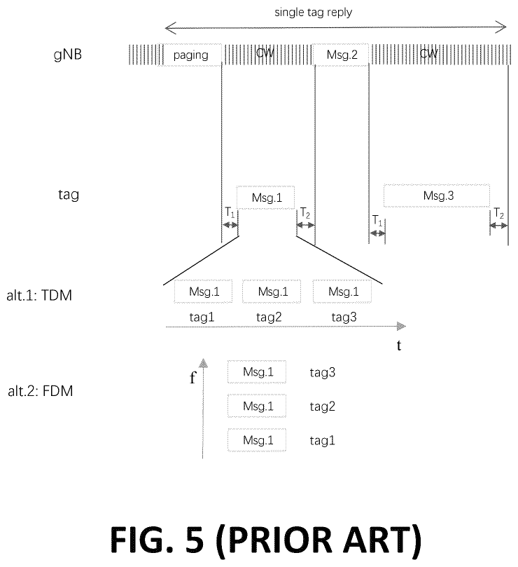

FIG. 6 is a reproduction of FIG. 6: Spectrum of Miller modulated subcarrier with different M value and BLF, from R1-2404459.

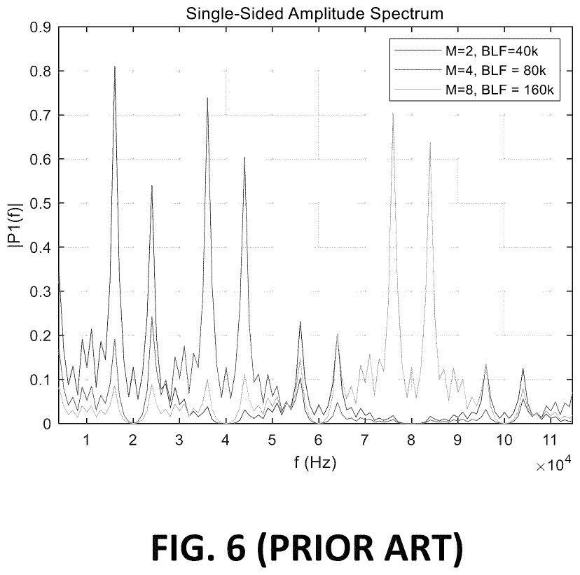

FIG. 7 is a reproduction of FIG. 7: Non-immediate reply for TDM response in one slot, from R1-2404459.

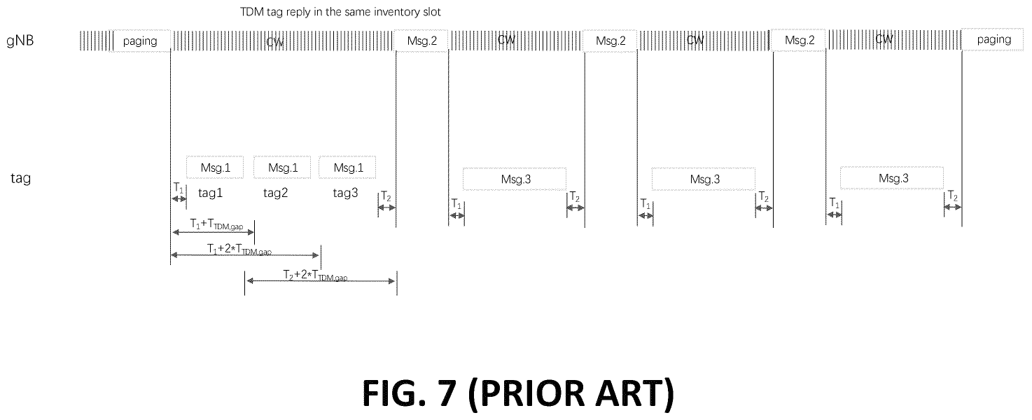

FIG. 8 is an example diagram showing TDM and FDM for Msg.1, in accordance with embodiments of the present invention.

FIG. 9 is an example diagram showing a non-immediate reply for a TDM response in one slot, in accordance with embodiments of the present invention.

FIG. 10 is an example diagram showing a random access procedure, where a first message, e.g., paging message, may indicate 18 Msg.1 resources, wherein there are three Msg.1 time occasions with six frequency resources in one/each Msg.1 time occasion, in accordance with embodiments of the present invention.

FIG. 11A is an example diagram showing a random access procedure, where a paging message may indicate 18 Msg.1 resources, wherein there are three Msg. 1 time occasions with six frequency resources in one/each Msg.1 time occasion, in accordance with embodiments of the present invention.

FIG. 11B is an example diagram showing a random access procedure, where a first message, e.g., paging message, may indicate 18 Msg.1 resources, wherein there are three Msg.1 time occasions with six frequency resources in one/each Msg.1 time occasion, in accordance with embodiments of the present invention.

FIG. 12 is a flow diagram of a method for a device in a wireless communication system comprising receiving a first message, performing a first D2R transmission, in response to the first message, on a first resource in a first time occasion, receiving a second message, which indicates information/indication associated with or for identifying the device, and performing a second D2R transmission, in response to the second message, on a second resource in a second time occasion, in accordance with embodiments of the present invention.

FIG. 13 is a flow diagram of a method for a device in a wireless communication system comprising receiving a first message, performing a first D2R transmission, in response to the first message, on a first resource in a first time occasion, receiving a second message, which indicates information/indication associated with or for identifying the device, and performing a second D2R transmission, in response to the second message, on a second resource in a second time occasion, in accordance with embodiments of the present invention.

FIG. 14 is a flow diagram of a method for a first device in a wireless communication system comprising receiving a first R2D message for paging at least the first device, transmitting a first D2R message comprising a first ID based on a first frequency shift, receiving a second R2D message indicating a set of IDs comprising at least the first ID, and transmitting a second D2R message based on a second frequency shift when the second R2D message indicates information associated with a set of frequency shifts, in accordance with embodiments of the present invention.

FIG. 15 is a flow diagram of a method for a reader in a wireless communication system comprising transmitting a first R2D message for paging at least a first device, receiving a first D2R message comprising a first ID based on a first frequency shift, transmitting a second R2D message indicating a set of IDs comprising at least the first ID, and receiving a second D2R message, from the first device, based on a second frequency shift when the second R2D message indicates information associated with a set of frequency shifts, in accordance with embodiments of the present invention.

### DETAILED DESCRIPTION

The invention described herein can be applied to or implemented in exemplary wireless communication systems and devices described below. In addition, the invention is described mainly in the context of the 3GPP architecture reference model. However, it is understood that with the disclosed information, one skilled in the art could easily adapt for use and implement aspects of the invention in a 3GPP2 network architecture as well as in other network architectures.

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A (Long Term Evolution Advanced) wireless access, 3GPP2 UMB (Ultra Mobile Broadband), WIMAX®, 3GPP NR (New Radio), or some other modulation techniques.

In particular, the exemplary wireless communication systems and devices described below may be designed to support one or more standards such as the standard offered by a consortium named “3rd Generation Partnership Project” referred to herein as 3GPP, including: [1] RP-240826, “Revised SID: Study on solutions for Ambient IoT (Internet of Things) in NR”; [2] R1-2401937, “Final Report of 3GPP TSG RAN WG1 #116 v1.0.0 (Athens, Greece, February 26th-Mar. 1, 2024)”; [3] R1-2403821, “Final Report of 3GPP TSG RAN WG1 #116b v1.0.0 (Changsha, China, April 15th-19th, 2024)”; [4] RAN1 Chair's Notes for 3GPP TSG RAN WG1 #117 (Fukuoka City, Fukuoka, Japan, May 20th-24th, 2024); [5] Report of 3GPP TSG RAN WG2 meeting #126, Fukuoka, Japan; [6] 3GPP TS 38.213 V18.2.0 (2024-03) 3GPP; TSG RAN; NR; Physical layer procedures for control (Release 18); and [7] R1-2404459, “Discussion on frame structure and timing aspects for A-IoT”, CMCC. The standards and documents listed above are hereby expressly and fully incorporated herein by reference in their entirety.

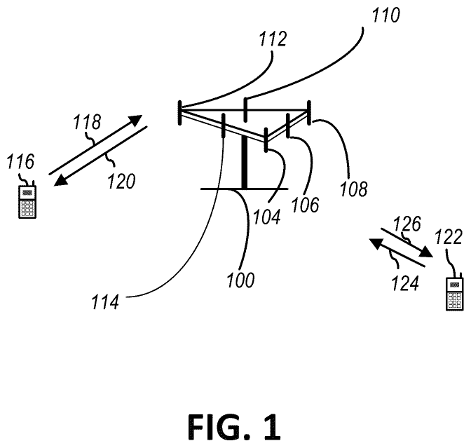

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal (AT) 116 is in communication with antennas 112 and 114, where antennas 112 and 114 transmit information to access terminal 116 over forward link 120 and receive information from AT 116 over reverse link 118. AT 122 is in communication with antennas 106 and 108, where antennas 106 and 108 transmit information to AT 122 over forward link 126 and receive information from AT 122 over reverse link 124. In a FDD system, communication links 118, 120, 124 and 126 may use different frequency for communication. For example, forward link 120 may use a different frequency than that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage normally causes less interference to access terminals in neighboring cells than an access network transmitting through a single antenna to all its access terminals.

The AN may be a fixed station or base station used for communicating with the terminals and may also be referred to as an access point, a Node B, a base station, an enhanced base station, an eNodeB, or some other terminology. The AT may also be called User Equipment (UE), a wireless communication device, terminal, access terminal or some other terminology.

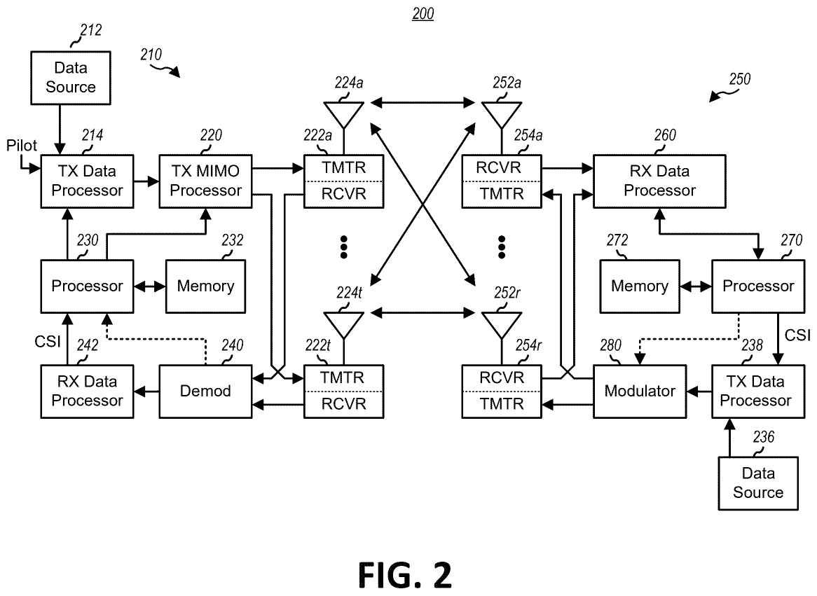

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (e.g., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230. A memory 232 is coupled to processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

Memory 232 may be used to temporarily store some buffered/computational data from 240 or 242 through Processor 230, store some buffed data from 212, or store some specific program codes. And Memory 272 may be used to temporarily store some buffered/computational data from 260 through Processor 270, store some buffed data from 236, or store some specific program codes.

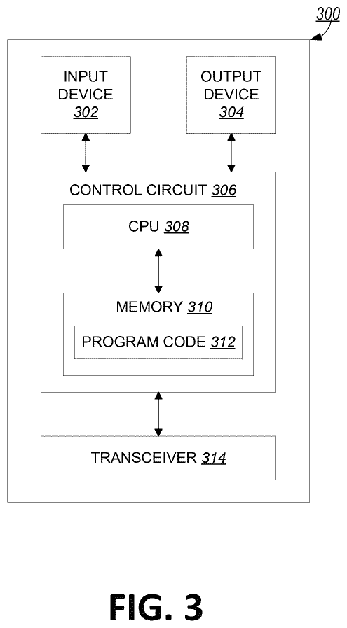

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1, and the wireless communications system is preferably the NR system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly.

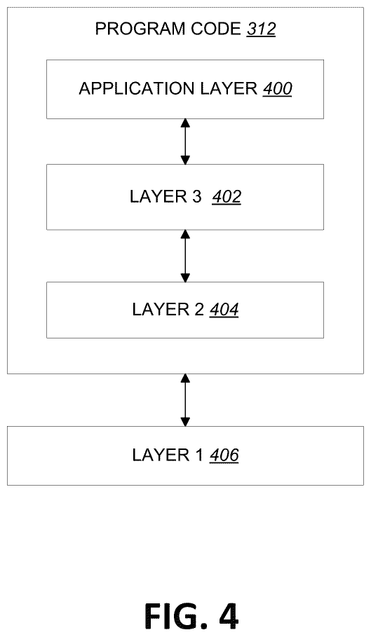

FIG. 4 is a simplified block diagram of the program code 312 shown in FIG. 3 in accordance with an embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

For LTE, LTE-A, or NR systems, the Layer 2 portion 404 may include a Radio Link Control (RLC) layer and a Medium Access Control (MAC) layer. The Layer 3 portion 402 may include a Radio Resource Control (RRC) layer.

Any two or more than two of the following paragraphs, (sub-) bullets, points, actions, or claims described in each invention paragraph or section may be combined logically, reasonably, and properly to form a specific method.

Any sentence, paragraph, (sub-) bullet, point, action, or claim described in each of the following invention paragraphs or sections may be implemented independently and separately to form a specific method or apparatus. Dependency, e.g., “based on”, “more specifically”, “example”, etc., in the following invention disclosure is just one possible embodiment which would not restrict the specific method or apparatus.

The study item of Ambient Internet of Things is specified in [1] RP-240826 as below:

### QUOTATION [1] START

### 3 Justification

In recent years, IoT has attracted much attention in the wireless communication world. More ‘things’ are expected to be interconnected for improving productivity efficiency and increasing comforts of life. Further reduction of size, complexity, and power consumption of IoT devices can enable the deployment of tens or even hundreds of billion IoT devices for various applications and provide added value across the entire value chain. It is impossible to power all the IoT devices by battery that needs to be replaced or recharged manually, which leads to high maintenance cost, serious environmental issues, and even safety hazards for some use cases (e.g., wireless sensor in electric power and petroleum industry).

Most of the existing wireless communication devices are powered by battery that needs to be replaced or recharged manually. The automation and digitalization of various industries open numbers of new markets requiring new IoT technologies of supporting batteryless devices with no energy storage capability or devices with energy storage that do not need to be replaced or recharged manually. The form factor of such devices must be reasonably small to convey the validity of target use cases.

An Ambient Internet-of-Things (IoT) device/User Equipment (UE) would have ultra-low complexity, a very small device size and a long life cycle. The ambient IoT device/UE would have complexity and power consumption orders of magnitude lower than the existing 3GPP Low-Power Wide-Area (LPWA) technologies (e.g., Narrowband (NB)-IoT, enhanced Machine Type Communication (eMTC)). The ambient IoT device/UE may not have energy storage or may have energy storage. The energy of an Ambient IoT device/UE may be provided through the harvesting of radio waves, light, motion, heat, or any other power source that could be suitable. The energy and/or power source may be provided one-shot (e.g., unexpected or aperiodically) or periodically or continuously. In one embodiment, the power/energy of the Ambient IoT device/UE may be provided from a carrier wave from the network and/or an intermediate node. In Topology 1, the Ambient IoT device/UE would directly and bidirectionally communicate with a base station. In Topology 2, the Ambient IoT device/UE would communicate bidirectionally with an intermediate node (e.g., a UE or a relay node) between the Ambient IoT device/UE and the base station. The Uplink (UL) transmission of the Ambient IoT device/UE may be generated internally by the device/UE, or be backscattered on the carrier wave provided externally. More details regarding Ambient IoT (device/UE) could be found in the study item [1] RP-240826 and TR 38.848 [5] R1-2403821.

According to study item of Ambient IoT [1] RP-240826, the Ambient IoT UE has limited energy storage (possibly even with no energy storage). Comparing a New Radio (NR) UE with power consumption of mW (e.g., maximum UE transmit power 23 dBm corresponds to 199.5 mW), output power of the Ambient IoT UE may be typically from 1 μW to a few hundreds of μW. Currently, the general scope is to address the following types of Ambient IoT UEs:
A first type of Ambient IoT UE may have 1 μW peak power consumption, with energy storage, with neither Downlink (DL) nor UL amplification. Transmission from the first type of Ambient IoT UE may be backscattered on a carrier wave provided externally. The first type of Ambient IoT UE may be a type of device 1, e.g., as described in [2] R1-2401937. The first type of Ambient IoT UE may be and/or comprise device type 1.
A second type of Ambient IoT UE may have ≤ a few hundred μW peak power consumption, with energy storage, with DL and/or UL amplification. Transmission from the second type of Ambient IoT UE may be backscattered on a carrier wave provided externally (e.g., a type of Device 2a) or generated internally by the UE (e.g., a type of Device 2b). The second type of Ambient IoT UE may be a type of Device 2a and/or Device 2b, e.g., as described in [2] R1-2401937. The second type of Ambient IoT UE may be and/or comprise device type 2, device type 2a, and/or device type 2b.

In Ambient IoT design, the device may receive a paging message via one or more first Physical Reader to (Ambient IoT) Device Channel (PRDCH) transmission from a reader. In response to (or after) the paging message, the device may trigger/perform an access procedure. In (a round of) the access procedure, the device may transmit a Msg1 via a first Physical (Ambient IoT) Device to Reader Channel (PDRCH) to a reader. In response to (or after) transmission of the Msg1, the device may monitor/receive a Msg2 via a second PRDCH transmission from the reader. If the Msg2 indicates information of the device, the device may transmit a Msg3 via a second PDRCH to the reader, in response to the Msg2. If the Msg2 does not indicate information of the device, the device may not perform a Msg3 transmission. The access procedure may be (successfully) completed and/or be considered as successful in a contention resolution, after/upon/in response to transmission of the Msg3 and/or receive/detect a corresponding (subsequent) Reader-to-Device (R2D) transmission, e.g., Acknowledge/Acknowledgement (ACK) to the Msg3.

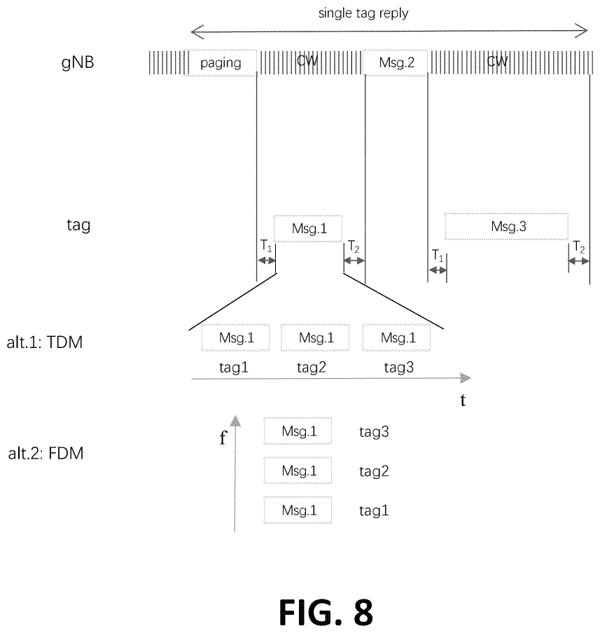

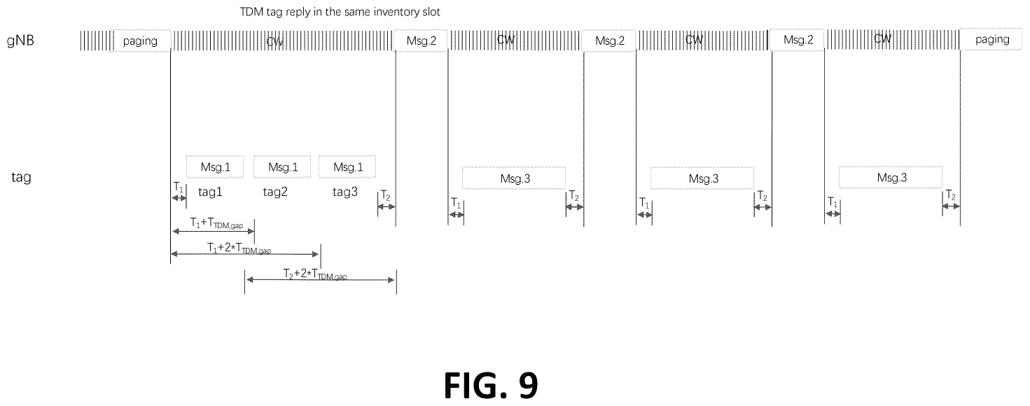

In RAN1 #116bis ([3] R1-2403821), it is agreed to study time-domain multiple access and frequency-domain multiple access for Device-to-Reader (D2R) transmission. Whether code-domain multiple access is feasible and necessary for D2R transmissions for all devices is For Future Study (FFS). As an instance shown in FIG. 8, quoted from [7] R1-2404459, the paging message from the reader (e.g., the NR Node B (gNB) in FIG. 8) may trigger one or more devices (e.g., tag1, tag2, tag3 in FIG. 8) to transmit a Msg.1 to the reader. In a Time-Division Multiplexing (TDM) manner, there are three available time occasions in FIG. 8. A device may transmit its Msg.1 in one time occasion. In a Frequency-Division Multiplexing (FDM) manner, there are three available frequency resources in FIG. 8. A device may transmit its Msg. 1 in one frequency resource. As an instance shown in FIG. 9, quoted from [7] R1-2404459, after the reader (e.g., the gNB in FIG. 9) receives three Msg. 1s from three devices (e.g., tag1, tag2, tag3 in FIG. 9), the reader may transmit Msg.2 sequentially for triggering the three devices to transmit corresponding Msg.3s to the reader. FIG. 9 shows the TDM response, wherein one Msg.2 is utilized for triggering one device to transmit its corresponding Msg.3. For different devices, the reader will transmit different Msg.2s in non-overlapped TDM occasions, such that Msg.3s from different devices will also transmit in non-overlapped TDM occasions.

For Msg.1 in the FDM manner, it is unclear how to handle/schedule Msg.2 and Msg.3 transmissions. One possible way is that the reader transmits multiple Msg.2s in different frequency resources in one TDM occasion. However, it will induce receiving/decoding complexity for devices, especially Ambient (A)-IoT devices capable with ultra-low complexity.

Besides, given Time-Division Multiple Access (TDMA) and/or Frequency-Division Multiple Access (FDMA), there can be multiple Msg.1 resources associated with a paging message. One issue is how to allocate the multiple Msg.1 resources. Another issue is that how does the device select which one Msg. 1 resource for performing its Msg. 1 transmission when a device receives the paging message.

To deal with the above issues and achieve certain benefits, various concepts, mechanisms, methods, aspects, and embodiments are provided below.

### Concept A

A reader (e.g., a network node or an intermediate node) may perform a first message for triggering a (random) access procedure. Preferably in certain embodiments, the (random) access procedure may be a contention-based access procedure or contention-free access procedure. Preferably in certain embodiments, the (random) access procedure may be/comprise an inventory procedure. Preferably in certain embodiments, the (random) access procedure may be/comprise a command procedure. Preferably in certain embodiments, the (random) access procedure may be/comprise an “inventory and command” procedure. Preferably in certain embodiments, the first message may be/comprise any of a (A-IoT) paging message, Msg.0, or initial trigger message. Preferably in certain embodiments, the reader may perform one or more first R2D transmissions for transmitting the first message to one or more (Ambient IoT) devices.

When (or in response to) a first device receives the first message, the first device may perform a first D2R transmission. Preferably in certain embodiments, if/when the first message indicates information/indication associated with the first device, the first device may perform the first D2R transmission in response to the first message. Preferably in certain embodiments, if/when the first message does not indicate information/indication associated with the first device, the first device may not perform any D2R transmission in response to the first message. Preferably in certain embodiments, the information/indication associated with the first device may comprise any one or combinations of a target Identification/Identity (ID) indicated by the first message matches (some or full of) a device ID of the first device, a target group ID indicated by the first message matches (some or full of) a group ID which the first device belongs to, a device type indicated by the first message matches a device type of the first device, one or more values indicated by the first message match one or more flag/field/stored values of the first device. Preferably in certain embodiments, the first D2R transmission may be/comprise Msg.1. Preferably in certain embodiments, the first D2R transmission may comprise an ID generated by the first device and/or (part or full of) a device ID of the first device.

Preferably in certain embodiments, for (one round of) the (random) access procedure, the first message may indicate one or more first time occasions, e.g., N first time occasions (in one first frequency resource). Additionally and/or alternatively, for (one round of) the (random) access procedure, the first message may indicate one or more first frequency resources, e.g., M first frequency resources (in one first time occasion).

Concept A comprises that the first message may comprise one or more fields for indicating the one or more first frequency resources (within one time occasion).

The first message may comprise a first field for indicating a (available) number of frequency shifts. Preferably in certain embodiments, the first message may comprise a second field for indicating a frequency offset/granularity of frequency shift. Preferably or alternatively in certain embodiments, the frequency offset/granularity of frequency shift may be configured, fixed, or specified. Preferably in certain embodiments, the frequency offset/granularity of frequency shift may be in units of Hz, kHz, subcarrier, or Physical Resource Block (PRB).

Preferably in certain embodiments, the device may receive the first message and/or carrier wave signal in a frequency resource. Alternatively, the first message may comprise a third field for indicating a frequency resource as reference. Preferably or alternatively in certain embodiments, the frequency resource as reference may be configured, fixed, or specified.

Preferably in certain embodiments, the device may determine/derive the one or more first frequency resources based on (1) (center frequency of) the frequency resource as reference, (2) the (available) number of frequency shifts, and/or (3) the frequency offset/granularity of a frequency shift.

For instance, the device may receive the first message and/or carrier wave signal in a frequency resource f₀, or the frequency resource as reference may be f₀. The frequency offset/granularity of frequency shift may be fᵤₙᵢₜ. The (available) number of frequency shifts may be indicated as M. Preferably in certain embodiments, the device may determine/derive (starting frequencies or center frequencies of) the one or more first frequency resources based on f₀−((M−1)/2)·fᵤₙᵢₜ, f₀−((M−1)/2−1)·fᵤₙᵢₜ, . . . , f₀−1·fᵤₙᵢₜ, f₀, f₀+1·fᵤₙᵢₜ, . . . , f₀+((M−1)/2−1)·fᵤₙᵢₜ, f₀+((M−1)/2)·fᵤₙᵢₜ. The amount/number of the one or more first frequency resources may be M. The M value may be odd. For the M frequency resources, there is one frequency resource with a starting frequency or center frequency in f₀. Alternatively, the device may determine/derive (starting frequencies or center frequencies of) the one or more first frequency resources based on f₀−(M/2)·fᵤₙᵢₜ, f₀−(M/2−1)·fᵤₙᵢₜ, . . . , f₀−1·fᵤₙᵢₜ, f₀+1·fᵤₙᵢₜ, . . . , f₀+(M/2−1)·fᵤₙᵢₜ, f₀+(M/2)·fᵤₙᵢₜ. The amount/number of the one or more first frequency resources may be M. The M value may be even. For the M frequency resources, there is no frequency resource with a starting frequency or center frequency in f₀.

When (or in response to) the first device receives the first message, the first device may determine/derive one or more first (time and frequency) resources based on the first message. The first device may determine/derive/select a first resource, among the one or more first resources, for performing the first D2R transmission (in a round of the access procedure). The first resource(s) may be or comprise frequency resource(s) and/or time resource(s)/occasion(s). Preferably in certain embodiments, the first device may determine/derive/select a first time occasion, among the one or more first time occasions (e.g., N time occasions), for performing the first D2R transmission (in a round of the access procedure). Preferably in certain embodiments, the first device may determine/derive/select a first frequency resource, among the one or more frequency resources (e.g., M frequency resources), for performing the first D2R transmission (in a round of the access procedure).

### Concept B

As described in Concept A, when (or in response to) the first device receives the first message (e.g., paging message, Msg.0, or initial trigger message) from the reader, the first device may perform a first D2R transmission. The first D2R transmission may be/comprise Msg.1. Preferably in certain embodiments, the first D2R transmission may comprise an ID generated by the first device and/or (part or full of) a device ID of the first device.

Preferably in certain embodiments, after the first device performs the first D2R transmission, the first device may monitor or (attempt to) receive a second message from the reader. The second message may be/comprise Msg.2 or a contention resolution. Preferably in certain embodiments, when the first device receives the second message, the first device may perform a second D2R transmission. Preferably in certain embodiments, if/when the second message indicates information/indication associated with the first device, the first device may perform the second D2R transmission in response to the second message. Preferably in certain embodiments, if/when the second message does not indicate information/indication associated with the first device, the first device may not perform any second D2R transmission in response to the second message. Preferably in certain embodiments, the information/indication associated with the first device may be/comprise information comprised in the first D2R transmission (which can identify the first device), e.g., the ID generated by the first device or the (part or full of) a device ID of the first device which is comprised in the first D2R transmission. Preferably in certain embodiments, the second D2R transmission may be/comprise Msg.3. Preferably in certain embodiments, the second D2R transmission may comprise some data of the first device, buffer status of the first device, and/or power status of the first device. Preferably in certain embodiments, if (at least) the first D2R transmission comprises part of the device ID of the first device, the second D2R transmission may comprise a remaining device ID of the first device.

Preferably in certain embodiments, after the reader receives one or more first D2R transmissions (e.g., one or more Msg.1s) from one or more devices, the reader may transmit one or multiple second messages for triggering one or more second D2R transmissions from the one or more devices. Preferably in certain embodiments, the reader may transmit the one or multiple second messages in the same frequency resource (in different timing) as the first message and/or carrier wave.

Preferably in certain embodiments, the first device may perform the second D2R transmission on a second resource (e.g., a second frequency resource in a second time occasion). Concept B comprises how the first device determines the second resource for performing the second D2R transmission, when/if the first device receives the second message and/or the second message indicates information/indication associated with the first device.

In one embodiment B1, the second message may indicate a set of second (frequency) resources in a/one second time occasion. The reader may transmit one or multiple second messages. Preferably in certain embodiments, the second message may indicate a set of information/indications (e.g., a list of information/indications) associated with a set of devices or for identifying the set of devices. Preferably in certain embodiments, the number of the set of second (frequency) resources may be the same as or larger than the number of the set of information/indications associated with or for identifying the set of devices. Preferably in certain embodiments, the set of second (frequency) resources may be ordered/indexed, e.g., starting from the lowest frequency or from the highest frequency, or starting from the smallest frequency shift (e.g., from the second message and/or carrier wave signal or from f₀ in Concept A), or starting from the largest frequency shift (e.g., from the second message and/or carrier wave signal or from f₀ in Concept A). Preferably in certain embodiments, when the first device receives the second message, the first device may determine the second resource, for performing the second D2R transmission, from the set of second (frequency) resources based on an order or an index of information/indications associated with or for identifying the first device within the set of information/indications associated with or for identifying the set of devices. Preferably in certain embodiments, the first device may determine/derive the second time occasion based on a reception time of the second message and/or an indication provided in the second message. The first device may perform the second D2R transmission on the determined second resource in the second time occasion.

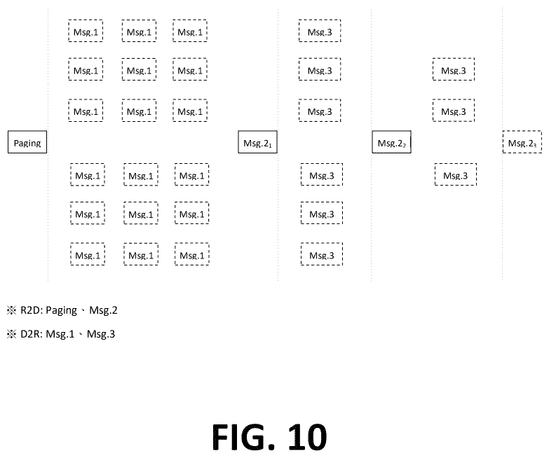

For an instance as shown in FIG. 10, the first message, e.g., paging message, may indicate 18 Msg.1 resources, wherein there are three Msg. 1 time occasions with six frequency resources in one/each Msg. 1 time occasion. The first device may perform the first D2R transmission, comprising specific bits of the first device, in one of the 18 Msg.1 resources. Then, the first device may monitor or (attempt to) receive a second message from the reader. In an instance, the first device may receive the Msg.2₁, wherein the Msg.2₁ indicates six frequency resources (e.g., the six Msg.3 blocks after Msg.2₁ and before Msg.2₂) and indicates six information/indications for identifying devices. The six frequency resources may be ordered/indexed. When/if the specific bits of the first device match the 4-th information/indication among the six information/indications for identifying devices, the first device may determine the second resource, as the 4-th frequency resource among the six frequency resources. In an instance, the first device may receive the Msg.2₂, wherein the Msg.2₂ indicates three frequency resources (e.g., the three Msg.3 blocks after Msg.2₂) and indicates three information/indications for identifying devices. The three frequency resources may be ordered/indexed. When/if the specific bits of the first device match the 1-st information/indication among the three information/indications for identifying devices, the first device may determine the second resource, as the 1-st frequency resource among the three frequency resources.

In one embodiment B2, the second message may indicate a set of second resources in/within a set of second time occasions. The reader may transmit one second message. Preferably in certain embodiments, the second message may indicate a set of information/indications (e.g., a list of information/indications) associated with a set of devices or for identifying the set of devices. Preferably in certain embodiments, the set of second resources may be first ordered/indexed in time domain, and then ordered/index in frequency domain (e.g., starting from the lowest frequency or from the highest frequency, or starting from the smallest frequency shift (e.g., from the second message and/or carrier wave signal or from f₀ in Concept A), or starting from the largest frequency shift (e.g., from the second message and/or carrier wave signal or from f₀ in Concept A)). Alternatively, the set of second resources may be first ordered/indexed in frequency domain, and then ordered/index in time domain. Preferably in certain embodiments, when (or in response to) the first device receives the second message, the first device may determine the second resource, for performing the second D2R transmission, from the set of second resources based on an order or an index of information/indications associated with or for identifying the first device within the set of information/indications associated with or for identifying the set of devices. Preferably in certain embodiments, the first device may determine/derive a second time occasion based on the determined second resource. The first device may perform the second D2R transmission on the determined second resource in the second time occasion.

In one embodiment B3, the second message may not indicate a set of second (frequency) resources. There may be association between Msg.1 resource and Msg.3 resource. Preferably in certain embodiments, there may be association between Msg.1 (frequency) resource and Msg.3 (frequency) resource. Msg. 1 (frequency) resource and Msg.3 (frequency) resource may be 1-to-1 mapping. Preferably in certain embodiments, there may be association between Msg.1 time occasion and Msg.2 transmission/reception time. Msg.1 time occasion and Msg.2 transmission/reception time may be 1-to-1 mapping or multiple-to-1 mapping. The first device may determine a (frequency) resource for the second D2R transmission based on the association.

The reader may transmit one or multiple second messages. Preferably in certain embodiments, when/if the first message indicates N first time occasions, the reader may transmit N second messages (separately) in N transmission times. Preferably in certain embodiments, the reader may transmit a/one second message in a/one transmission time. Preferably in certain embodiments, if/when the first device performs the first D2R transmission in the n-th first time occasion among the N first time occasions, the first device may monitor or (attempt to) receive the second message in the n-th transmission/reception time among the N transmission/reception times. Preferably in certain embodiments, if/when the first device performs the first D2R transmission in the n-th first time occasions among the N first time occasions, the first device may monitor or (attempt to) receive the n-th second message transmitted in the n-th transmission/reception time. The first device may not decode second message(s) in other transmission/reception times (and/or may detect existence of second message(s) in other transmission times), except in the n-th transmission/reception time.

Preferably in certain embodiments, the/a second message may indicate a set of information/indications (e.g., a list of information/indications) associated with a set of devices or for identifying the set of devices. Preferably in certain embodiments, the number of the one or more first frequency resources, e.g., M first frequency resources, indicated by the first message (e.g., Msg.1 (frequency) resources in a Msg.1 time occasion) may be the same as or larger than the number of the set of information/indications associated with or for identifying the set of devices. Preferably in certain embodiments, when (or in response to) the first device receives the second message (and if/when the second message indicates information/indication associated with the first device), the first device may determine the second frequency resource, for performing the second D2R transmission, based on the first frequency resource which the first device performs the first D2R transmission on. The first device may (always) consider/determine/select the second frequency resource, for the first device to perform the second D2R transmission, being the same as the first frequency resource for the first device to perform the first D2R transmission. The first device may consider/determine/select the second frequency resource for the second D2R transmission being the same as the first frequency resource for the first D2R transmission if (at least) the second frequency resource is not indicated in the second message (or the first device cannot derive the second frequency resource from the second message). Preferably in certain embodiments, the first device may determine/derive the second time occasion based the reception time of the second message and/or indication provided in the second message. The first device may perform the second D2R transmission on the determined second resource in the second time occasion.

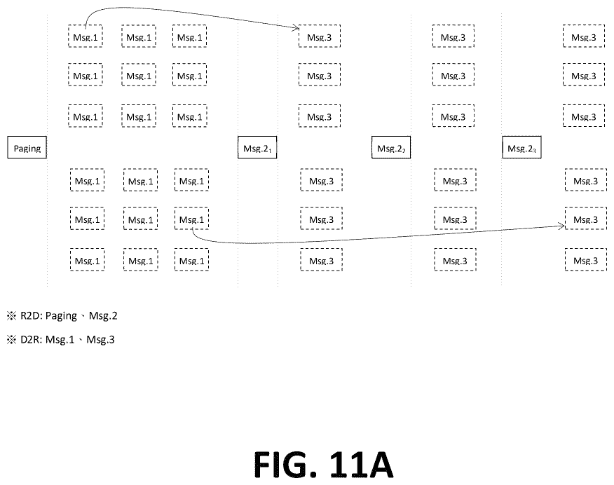

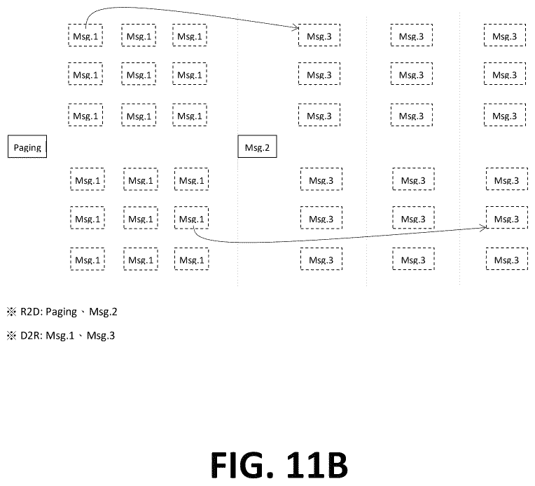

For an instance shown in FIG. 11A, the first message, e.g., paging message, may indicate 18 Msg. 1 resources, wherein there are three Msg. 1 time occasions with six frequency resources in one/each Msg. 1 time occasion. The first device may perform the first D2R transmission, comprising specific bits of the first device, in one of the 18 Msg.1 resources. Then, the first device may monitor or (attempt to) receive a second message from the reader, e.g., in a transmission/reception time associated with or based on the first resource which the first D2R transmission is transmitted on. In an instance, the first device may perform the first D2R transmission in the 1-st Msg.1 time occasion and on the frequency resource with the highest frequency among the 18 Msg.1 resources, as shown in FIG. 11A. Then, the first device may monitor and (attempt to) receive Msg.2 in the 1-st Msg.2 transmission/reception time. Preferably in certain embodiments, when/if the first device receives the Msg.2₁ in the 1-st Msg.2 transmission/reception time and the Msg.2₁ comprises/indicates information/indication associated with or for identifying the first device, the first device may perform the second D2R transmission on the second resource, which is with the frequency resource with the first D2R transmission and in the second time occasion associated with the 1-st Msg.2 transmission/reception time. Preferably in certain embodiments, when/if the first device receives the Msg.2₁ in the 1-st Msg.2 transmission/reception time, and when/if the specific bits of the first device match any information/indications associated with or for identifying devices in the second message Msg.2₁, the first device may determine the second resource, as the frequency resource with the first D2R transmission and in the second time occasion associated with the transmission/reception time of the second message. In an instance, the first device may perform the first D2R transmission in the 3-rd Msg.1 time occasion and on the 2-nd frequency resource in the 3-rd Msg.1 time occasion, as shown in FIG. 11A. Then, the first device may monitor and (attempt to) receive Msg.2 in the 3-rd Msg.2 transmission/reception time. Preferably in certain embodiments, when/if the first device receives the Msg.2₃ in the 3-rd Msg.2 transmission/reception time, and the Msg.2₃ comprises/indicates information/indication associated with or for identifying the first device, the first device may perform the second D2R transmission on the second resource, which is with the frequency resource with the first D2R transmission (i.e., the 2-nd frequency resource) and in the second time occasion associated with the 3-rd Msg.2 transmission/reception time. Preferably in certain embodiments, when/if the first device receives the Msg.2₃ in the 3-rd Msg.2 transmission/reception time, and when/if the specific bits of the first device matches any information/indications associated with or for identifying devices in the second message Msg.2₃, the first device may determine the second resource, as the frequency resource with the first D2R transmission and in the second time occasion associated with the transmission/reception time of the second message. Preferably in certain embodiments, the reader may transmit a third message, which comprises D2R scheduling information. The D2R scheduling information may trigger a receiving device to perform a corresponding third D2R transmission.

In one embodiment B4, the second message may not indicate a set of second (frequency) resources. There may be an association between a Msg. 1 resource and a Msg.3 resource. Preferably in certain embodiments, there may be association between a Msg.1 (frequency) resource and a Msg.3 (frequency) resource. The Msg. 1 (frequency) resource and the Msg.3 (frequency) resource may be 1-to-1 mapping. Preferably in certain embodiments, there may be association between a Msg. 1 time occasion and a Msg.3 time occasion. The Msg.1 time occasion and the Msg.3 time occasion may be 1-to-1 mapping. The first device may determine a (frequency) resource for the second D2R transmission based on the association.

The reader may transmit one second message. Preferably in certain embodiments, when/if the first message indicates N first time occasions, the reader may transmit the one second message in one transmission time. Preferably in certain embodiments, if/when the first device performs the first D2R transmission in any first time occasion among the N first time occasions, the first device may monitor or (attempt to) receive the second message in the one transmission/reception time. Preferably in certain embodiments, if/when the first device performs the first D2R transmission in any first time occasions among the N first time occasions, the first device may monitor or (attempt to) receive the n-th second message transmitted in the one transmission/reception time.

Preferably in certain embodiments, the/a second message may indicate a set of information/indications (e.g., a list of information/indications) associated with a set of devices or for identifying the set of devices. Preferably in certain embodiments, the number of the one or more first resources, e.g., N·M first resources, indicated by the first message (e.g., Msg.1 resources with/in the Msg. 1 time occasions) may be the same as or larger than the number of the set of information/indications associated with or for identifying the set of devices. Preferably in certain embodiments, when the first device receives the second message (and if/when the second message indicates information/indication associated with the first device), the first device may determine the second frequency resource, for performing the second D2R transmission, based on the first frequency resource which the first device performs the first D2R transmission on. The first device may (always) consider/determine/select the second frequency resource, for the first device to perform the second D2R transmission, being the same as the first frequency resource for the first device to perform the first D2R transmission. The first device may consider/determine/select the second frequency resource for the second D2R transmission being the same as the first frequency resource for the first D2R transmission if (at least) the second frequency resource is not indicated in the second message (or the first device cannot derive the second frequency resource from the second message). Preferably in certain embodiments, the first device may determine/derive the second time occasion based on the first time occasion which the first device performs the first D2R transmission in and/or the indication provided in the second message. Preferably in certain embodiments, the second message may indicate one or more second time occasions, wherein the number of the one or more second time occasions is the same as the number of the first time occasions. The first device may perform the second D2R transmissions on the determined second resource in the second time occasion.

For an instance shown in FIG. 11B, the first message, e.g., paging message, may indicate 18 Msg.1 resources, wherein there are three Msg.1 time occasions with six frequency resources in one/each Msg. 1 time occasion. The first device may perform the first D2R transmission, comprising specific bits of the first device, in one of the 18 Msg.1 resources. Then, the first device may monitor or (attempt to) receive a second message from the reader, e.g., in a/one transmission/reception time. In an instance, the first device may perform the first D2R transmission in the 1-st Msg. 1 time occasion and on the frequency resource with the highest frequency among the 18 Msg.1 resources, as shown in FIG. 11B. Then, the first device may monitor and (attempt to) receive Msg.2 in a Msg.2 transmission/reception time. Preferably in certain embodiments, when/if the first device receives the Msg.2 in the Msg.2 transmission/reception time and the Msg.2 comprises/indicates information/indication associated with or for identifying the first device, the first device may perform the second D2R transmission on the second resource, which is with the frequency resource with the first D2R transmission and in the 1-st second time occasion since the first D2R transmission is performed in the 1-st Msg. 1 time occasion. Preferably in certain embodiments, when/if the first device receives the Msg.2 in the Msg.2 transmission/reception time, and when/if the specific bits of the first device match any information/indications associated with or for identifying devices in the second message Msg.2, the first device may determine the second resource, as the frequency resource with the first D2R transmission and in the second time occasion associated with the first time occasion where the first D2R transmission is a performed message. In an instance, the first device may perform the first D2R transmission in the 3-rd Msg.1 time occasion and on the 2-nd frequency resource in the 3-rd Msg.1 time occasion, as shown in FIG. 11B. Then, the first device may monitor and (attempt to) receive Msg.2 in the Msg.2 transmission/reception time. Preferably in certain embodiments, when/if the first device receives the Msg.2 in the Msg.2 transmission/reception time, and the Msg.2₃ comprises/indicates information/indication associated with or for identifying the first device, the first device may perform the second D2R transmission on the second resource, which is with the frequency resource with the first D2R transmission (i.e., the 2-nd frequency resource) and in the 3-rd second time occasion associated with the 3-rd Msg. 1 time occasion. Preferably in certain embodiments, when/if the first device receives the Msg.2 in the Msg.2 transmission/reception time, and when/if the specific bits of the first device match any information/indications associated with or for identifying devices in the second message Msg.2, the first device may determine the second resource, as the frequency resource with the first D2R transmission and in the second time occasion associated with the first time occasion of the first D2R transmission.

Preferably in certain embodiments, (for any embodiments B1˜B4), after the first device performs the first D2R transmission (e.g., Msg.1), the first device may monitor or (attempt to) receive the second message from the reader. Preferably in certain embodiments, when/if the first device does not detect/receive any second message (e.g., Msg.2) in an initial/first transmission/reception time for the second message, the reader may consider no Msg.1 is successfully received in the reader and/or consider the first D2R transmission is not successfully received in the reader. Preferably in certain embodiments, when/if the first device receives another first message (e.g., another paging message, another Msg.0) (and does not detect/receive any second message) in the initial/first transmission/reception time for the second message, the reader may consider no Msg.1 is successfully received in the reader and/or consider the first D2R transmission is not successfully received in the reader. Preferably in certain embodiments, if/when the reader does not successfully receive any Msg.1 or any first D2R transmission on the one or more first frequency resources in the one or more first time occasions, the reader may transmit another first message (and does not transmit a second message) in the initial/first transmission/reception time for the second message.

Preferably in certain embodiments, for embodiment B3, if/when the reader does not receive/detect any Msg.1 or the first D2R transmission in a specific first time occasion, the reader may (still) transmit a second message in a specific (Msg.2) transmission time associated with the specific first time occasion (without indicating information associated with any devices). For instance, if/when the reader does not receive/detect any Msg.1 or the first D2R transmission in a 2-nd first time occasion among the N first time occasions, the reader may (still) transmit a second message in a 2-nd (Msg.2) transmission time.

Preferably in certain embodiments, one embodiment among the embodiments B1˜B4 may be applied as a default. Preferably in certain embodiments, one embodiment among the embodiments B1˜B4 may be applied as a configuration. Preferably in certain embodiments, an indication from the reader may indicate (a device) to apply which one embodiment among the embodiment sB1˜B4. Preferably in certain embodiments, the indication may be comprised/included in the first message and/or the second message. Preferably in certain embodiments, for different access procedures triggered by different first messages (e.g., different paging messages, different Msg.0), different embodiments may be applied. Preferably in certain embodiments, for different rounds of an access procedure, different embodiments may be applied. Preferably in certain embodiments, for different (types of) devices, different embodiments may be applied.

Preferably in certain embodiments, when (or in response to) the first device receives the third message, the first device may perform the corresponding third D2R transmission based on the D2R scheduling information. Preferably in certain embodiments, the third message may comprise information/indication associated with or for identifying the first device. Preferably in certain embodiments, the third message and/or the D2R scheduling information may indicate a minimum time between R2D and D2R and/or indicate a maximum time between R2D and D2R. Preferably in certain embodiments, the third message may be transmitted via a third R2D transmission from the reader. The third message and/or the D2R scheduling information may indicate a minimum time between the third R2D transmission (e.g., ending time of the third R2D transmission) and the corresponding third D2R transmission (e.g., starting time or ending time of the corresponding third D2R transmission) and/or indicate a maximum time between the third R2D transmission (e.g., ending time of the third R2D transmission) and the corresponding third D2R transmission (e.g., starting time or ending time of the corresponding third D2R transmission). Preferably in certain embodiments, the minimum time and/or the maximum time may be indicated, e.g., indicated by the third message and/or the D2R scheduling information. Preferably in certain embodiments, the minimum time and/or the maximum time may be specified or configurable for different types of D2R content (e.g., comprised in the corresponding third D2R transmission). Preferably in certain embodiments, association between the minimum time and/or the maximum time and the type of D2R content may be specified or configured. Preferably in certain embodiments, the minimum time and/or the maximum time may be different for a different type of D2R content. Preferably in certain embodiments, the minimum time and/or the maximum time may be different for different device types.

Preferably in certain embodiments, the minimum time and/or the maximum time associated with a D2R content as ACK (e.g., the corresponding third D2R transmission comprises the ACK) may (assume to) be shorter than the minimum time and/or the maximum time associated with a D2R content as data. Preferably in certain embodiments, the minimum time and/or the maximum time associated with a D2R content as a smaller data packet (e.g., the corresponding third D2R transmission comprises the smaller data packet) may (assume to) be shorter than the minimum time and/or the maximum time associated with a D2R content as a larger data packet (e.g., the corresponding third D2R transmission comprises the larger data packet).

Preferably in certain embodiments, the third message may be/comprise the first message. The corresponding third D2R transmission may be/comprise the first D2R transmission (e.g., Msg.1).

Preferably in certain embodiments, the third message may be/comprise the second message. The corresponding third D2R transmission may be/comprise the second D2R transmission (e.g., Msg.3).

Preferably in certain embodiments, the minimum time and/or the maximum time associated with the first D2R transmission (e.g., the corresponding third D2R transmission is/comprises Msg.1) may (assume to) be shorter than the minimum time and/or the maximum time associated with the second D2R transmission (e.g., the corresponding third D2R transmission is/comprises Msg.3).

Various examples and embodiments of the present invention are described below. For the methods, alternatives, concepts, examples, and embodiments detailed above and herein, the following aspects and embodiments are possible.

Note that any of above concepts, methods, alternatives, instances, and embodiments (e.g., in concept A, B) may be combined or applied simultaneously, in whole or in part.

Preferably in certain embodiments, one embodiment may be applied (e.g., when (explicitly) specified), when/if (at least) another one embodiment is applied as a default.

In one embodiment, in response to receiving an R2D message for paging (e.g., associated with a first device), the first device transmits a first D2R transmission (e.g., for Msg1) in a first frequency resource. The first D2R transmission (e.g., for Msg1) may comprises a first ID generated by the first device. The first ID may be a (e.g., 16-bit) random ID. The first device may receive an R2D transmission (e.g., for Msg2). The R2D transmission (e.g., for Msg2) may indicate at least a set of frequency resources for a (same) time occasion and a set of IDs associated with a set of devices. The set of IDs may comprise the first ID. The set of frequency resources may be allocated at and/or associated with the (same) time occasion. The R2D transmission (e.g., for Msg2) may not indicate different (or multiple) time occasions. In response to receiving the R2D transmission (e.g., for Msg2) which indicates the first ID, the first device may transmit a second D2R transmission (e.g., for Msg3) in a second frequency resource. The second frequency resource may be determined, among the set of frequency resources, based on an order of the first ID among the set of IDs. The first device may determine the second frequency resource from the set of frequency resources, based on the order of the first ID among the set of IDs. The frequency resource(s) may be/comprise or be associated with or correspond to (at least) frequency shift(s).

In one embodiment, in response to receiving an R2D message for paging (e.g., associated with a first device), the first device may transmit a first D2R transmission (e.g., for Msg1) in a first frequency resource. The first D2R transmission (e.g., for Msg1) may comprise a first ID generated by the first device. The first ID may be a (e.g., 16-bit) random ID. In response to receiving an R2D transmission (e.g., for Msg2) which indicates the first ID, the first device may transmit a second D2R transmission (e.g., for Msg3) in a second frequency resource. The R2D transmission (e.g., for Msg2) may indicate at least a set of IDs associated with a set of devices. The set of IDs may comprise the first ID. If the R2D transmission (e.g., for Msg2) does not indicate (information of) frequency resources, the second frequency resource may be determined as the same as the first frequency resource. If the R2D transmission (e.g., for Msg2) indicates at least a set of frequency resources for a (same) time occasion, the second frequency resource may be determined, among the set of frequency resources, based on an order of the first ID among the set of IDs. In case the second R2D transmission (e.g., for Msg2) does not indicate (information of) frequency resources, the first device may determine the second frequency resource as the same as the first frequency resource. In case the second R2D transmission (e.g., for Msg2) indicates at least a set of frequency resources for a (same) time occasion, the first device may determine the second frequency from the set of frequency resources based on the order of the first ID among the set of IDs. The set of frequency resources may be allocated at and/or associated with the (same) time occasion. The R2D transmission (e.g., for Msg2) may not indicate different (or multiple) time occasions (e.g., for the second D2R transmission). The frequency resource(s) may be/comprise or be associated with or correspond to (at least) frequency shift(s).

Preferably in certain embodiments, the D2R transmission may be/mean or comprise a PDRCH transmission.

Preferably in certain embodiments, the R2D transmission may be/mean or comprise a PRDCH transmission.

Preferably in certain embodiments, the intermediate node may be/comprise a transmitter of an intermediate node. Preferably in certain embodiments, the intermediate node may be/comprise a transmitter of R2D transmissions. Preferably in certain embodiments, the intermediate node may be/comprise a transmitter of Carrier Wave (CW) transmissions. Preferably in certain embodiments, the intermediate node may utilize the set of resources for transmitting R2D transmissions and not utilize the set of resources for receiving D2R transmissions, e.g., the “R1” in the scenario (Deployment scenario 2) D2T2-A1.

Preferably in certain embodiments, the intermediate node may be/comprise a receiver of an intermediate node. Preferably in certain embodiments, the intermediate node may be/comprise a receiver of D2R transmissions. Preferably in certain embodiments, the intermediate node may utilize the set of resources for receiving D2R transmissions and not utilize the set of resources for transmitting R2D transmissions, e.g., the “R2” in the scenario D2T2-A1.

Preferably in certain embodiments, the intermediate node may be/comprise a transmitter and a receiver of an intermediate node. Preferably in certain embodiments, the intermediate node may be/comprise a transmitter of R2D transmissions and a receiver of D2R transmissions. Preferably in certain embodiments, the intermediate node may be/comprise a transmitter of CW transmissions. Preferably in certain embodiments, the intermediate node may utilize the set of resources for transmitting R2D transmissions and utilize the set of resources for receiving D2R transmissions, e.g., the “R” in the scenario D2T2-A2, D2T2-B, and/or D2T2-C.

Preferably in certain embodiments, the Ambient IoT-related operation may be/comprise any of an access procedure, contention-based access procedure, contention-free access procedure, inventory procedure/operation, and/or communication procedure/operation (for Ambient IoT UEs/devices).

Preferably in certain embodiments, the intermediate node may be/mean a relay, Integrated Access and Backhaul (IAB) node, repeater which is capable of Ambient IoT. Preferably in certain embodiments, the intermediate node may be/mean a UE/device capable of Ambient IoT. Preferably in certain embodiments, the intermediate node may be/mean or replaced as an intermediate device. Preferably in certain embodiments, the intermediate node may access or connect to the network node.

Preferably in certain embodiments, the access procedure is utilized for Ambient IoT devices/UEs.

Preferably in certain embodiments, the device/UE may access or connect to the network/intermediate node via the access procedure. Preferably in certain embodiments, the device/UE may perform (data or control) transmission(s) and reception(s) with the network/intermediate node via the access procedure. The access procedure may comprise a (data or control) communication operation. Alternatively or preferably in certain embodiments, the access procedure may not comprise a (data or control) communication operation. Preferably in certain embodiments, the (data or control) communication operation may be/comprise (at least) transmission(s) and/or reception(s) between the device/UE and the network/intermediate node. The device/UE may perform the (data or control) communication operation comprising (at least) receiving a valid (R2D) response associated with a first (D2R) signal/transmission, transmitting a device/UE information after receiving the valid (R2D) response, receiving a specific indication/signaling, transmitting D2R data/signal transmission(s), and/or receiving R2D data/signal transmission(s).

Preferably in certain embodiments, the access procedure may be/mean (or include) an inventory procedure. Preferably in certain embodiments, the access procedure may be performed for inventory.

Preferably in certain embodiments, a frequency resource (e.g., corresponding to a frequency shift) for D2R may correspond to a D2R transmission/occupied bandwidth.

Preferably in certain embodiments, the D2R transmission/occupied bandwidth may be/mean (or include) frequency resources used for performing D2R transmission/reception. Preferably or alternatively in certain embodiments, the device may perform one PDRCH (restricted to be) within one D2R transmission/occupied bandwidth. Preferably in certain embodiments, the device may not perform (or prevent from performing) one PDRCH across multiple D2R transmission/occupied bandwidths. Preferably in certain embodiments, a D2R transmission/occupied bandwidth may be/mean/replace any of a (D2R) bandwidth part or a (D2R) sub-channel or a (D2R) frequency unit.

Preferably in certain embodiments, the D2R may be/mean or replaced/changed/represented as from the device/UE to the reader/network/intermediate node. Preferably in certain embodiments, the D2R may be/mean or replaced/changed/represented as UL.

Preferably in certain embodiments, the R2D may be/mean or replaced/changed/represented as from the reader/network/intermediate node to the device/UE. Preferably in certain embodiments, the R2D may be/mean or replaced/changed/represented as DL.

Preferably in certain embodiments, the PDRCH may be/mean or replaced/changed/represented as a channel/transmission from the device/UE to the reader/network/intermediate node. Preferably in certain embodiments, the PDRCH may be replaced by “physical channel for D2R (data and/or control) transmission”. Preferably in certain embodiments, the PDRCH transmission may be a transmission.

Preferably in certain embodiments, the PRDCH may be/mean or replaced/changed/represented as a channel/transmission from the reader/network/intermediate node to the device/UE. Preferably in certain embodiments, the PRDCH may be replaced by “physical channel for R2D (data and/or control) transmission”.

Preferably in certain embodiments, the time occasion/timing/Transmission Time Interval (TTI) may be/mean or replaced/changed/represented as a slot. Preferably in certain embodiments, the time occasion/timing/TTI may be/mean or replaced/changed/represented as a subframe. Preferably in certain embodiments, the time occasion/timing/TTI may be/mean or replaced/changed/represented as a sub-slot or mini-slot. Preferably in certain embodiments, the time occasion/timing/TTI may comprise a number (e.g., a predefined/fixed/(pre-) configured or indicated number) of symbols in time domain.

Preferably in certain embodiments, the time occasion/timing/TTI may be/mean or replaced/changed/represented as a transmission occasion. Preferably in certain embodiments, the time occasion/timing/TTI may be/mean or replaced/changed/represented as a reception occasion.

Preferably in certain embodiments, the transmission time may be/mean or replaced/changed/represented as a transmission occasion. Preferably in certain embodiments, the reception time may be/mean or replaced/changed/represented as a reception occasion.

Preferably in certain embodiments, the carrier wave (signal) above may be changed/represented/replaced as a DL signal/R2D or a DL/R2D channel. Preferably in certain embodiments, the carrier wave (signal) may be changed/represented/replaced as any signal for power source/supply (e.g., transmitted from network node or intermediate node).

Preferably in certain embodiments, the first/second device/UE may receive/detect the carrier wave (signal) in an R2D frequency bandwidth. Preferably or alternatively in certain embodiments, the first/second device/UE may receive/detect the carrier wave (signal) in a D2R frequency bandwidth.

Preferably in certain embodiments, the first/second device/UE may perform a D2R transmission via backscatter on the carrier wave (signal), e.g., provided externally or via generated internally by the first/second device/UE.

Preferably in certain embodiments, the network/intermediate node may transmit an indication related to or about whether a (serving or camped on) cell (of the UE or the network/intermediate node) supports more than one D2R frequency bandwidth or not. Preferably in certain embodiments, the UE may receive the indication related to or about whether the (serving or camped on) cell (of the UE or the network/intermediate node) supports more than one D2R frequency bandwidth or not. Preferably in certain embodiments, the indication may be provided/transmitted/comprised in the paging/query information. Preferably in certain embodiments, the indication may be provided/transmitted/comprised in the specific indication/signaling. Alternatively or preferably in certain embodiments, the indication may be provided/transmitted/comprised in a configuration provided from the network/intermediate node. Alternatively or preferably in certain embodiments, the indication may be specified or (pre-) configured or fixed.

Throughout the present disclosure, the “DL” may be replaced by “Reader to Device (R2D).” A DL transmission may be, be referred to, and/or be supplemented by a transmission from a reader to a device and/or an R2D transmission. A DL data may be, be referred to, and/or be supplemented by a data available on a reader side, a data to be transmitted from a reader to a device, and/or an R2D data. A DL transmission and/or DL data may comprise an indication, configuration, signal/signaling/signalling, and/or message from a reader.

Throughout the present disclosure, the “UL” may be replaced by “Device to Reader (D2R).” A UL transmission may be, be referred to, and/or be supplemented by a transmission from a device to a reader and/or a D2R transmission. A UL data may be, be referred to, and/or be supplemented by a data available on a device side, a data to be transmitted from a device to a reader, and/or a D2R data. A UL transmission and/or UL data may comprise an indication, signal/signaling, and/or message from a device. A UL grant may be one or more resources provided from the reader/Network (NW)/intermediate node, used by the device/UE and/or used to transmit/perform D2R transmission.

Throughout the present disclosure, the reader may be and/or be replaced by NW, UE, interrogator, and/or intermediate node. Throughout the present disclosure, the device may be and/or be replaced by UE, tag, and/or intermediate node. The device may be referred to as an Ambient IoT device. The “UE” may comprise a reader, tag, and/or device. The “NW/intermediate node” may comprise a reader and/or interrogator.

The UE/device may receive carrier wave(s) from a reader. The UE/device may receive carrier wave(s) from a node other than the reader.

Throughout the present disclosure, the Backscattering (BS) may be replaced by “Device to Reader (D2R)” or “UL”. The backscattering transmission may be, be referred to, and/or be supplemented by a transmission from a device to a reader and/or a D2R transmission, e.g., PDRCH.

Throughout the present disclosure, “Msg1” may be replaced by “Msg.1”. “Msg2” may be replaced by “Msg.2”. “Msg3” may be replaced by “Msg.3”.

The UE may be referred to the UE, a Radio Resource Control (RRC) layer of the UE, a Medium Access Control (MAC) entity of the UE, or a physical layer of the UE.

Throughout the present disclosure, the UE may be an Ambient IoT device/UE. The UE may be a device used for Ambient IoT. The UE may be a device capable of Ambient IoT. The UE may be an NR device. The UE may be a Long Term Evolution (LTE) device. The UE may be an IoT device. The UE may be a wearable device. The UE may be a sensor. The UE may be a stationary device. The UE may be a tag. Throughout the present disclosure, the following may be interchangeable: UE, (Ambient IoT) device.

The UE may not be a legacy UE. The legacy UE may be a non-Ambient IoT device. The legacy UE may perform different procedures from the Ambient IoT UE. The UE may be a legacy UE with capability to perform Ambient IoT procedures.

The network may be a network node. The network may be a base station. The network may be an access point. The network may be an evolved Node B (eNB). The network may be a gNB. The network may be a gateway. The network may be an interrogator.

Various examples and embodiments of the present invention are described below. For the methods, alternatives, concepts, examples, and embodiments detailed above and herein, the following aspects and embodiments are possible.

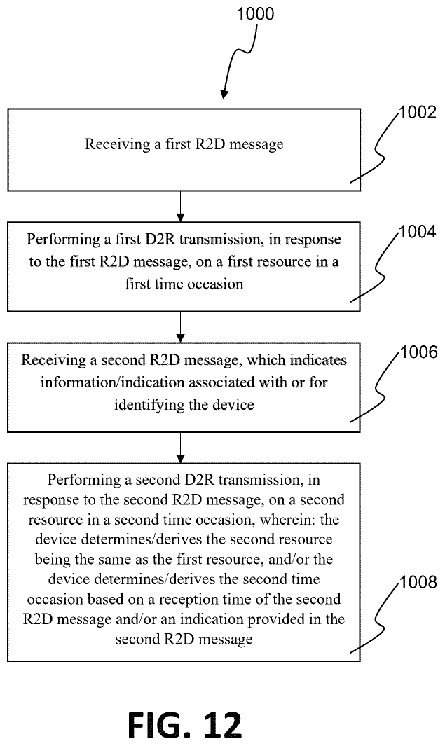

Referring to FIG. 12, with this and other concepts, systems, and methods of the present invention, a method 1000 for a device in a wireless communication system comprises receiving a first R2D message (step 1002), performing a first D2R transmission, in response to the first R2D message, on a first resource in a first time occasion (step 1004), receiving a second R2D message, which indicates information/indication associated with or for identifying the device (step 1006), and performing a second D2R transmission, in response to the second R2D message, on a second resource in a second time occasion, wherein: the device determines/derives the second resource being the same as the first resource, and/or the device determines/derives the second time occasion based on a reception time of the second R2D message and/or an indication provided in the second R2D message (step 1008).

Referring back to FIGS. 3 and 4, in one or more embodiments from the perspective of a device in a wireless communication system, the device 300 includes a program code 312 stored in memory 310 of the transmitter. The CPU 308 could execute program code 312 to: (i) receive a first R2D message; (ii) perform a first D2R transmission, in response to the first R2D message, on a first resource in a first time occasion; (iii) receive a second R2D message, which indicates information/indication associated with or for identifying the device; and (iv) perform a second D2R transmission, in response to the second R2D message, on a second resource in a second time occasion, wherein: the device determines/derives the second resource being the same as the first resource, and/or the device determines/derives the second time occasion based on a reception time of the second R2D message and/or an indication provided in the second R2D message. Moreover, the CPU 308 can execute the program code 312 to perform all of the described actions, steps, and methods described above, below, or otherwise herein.

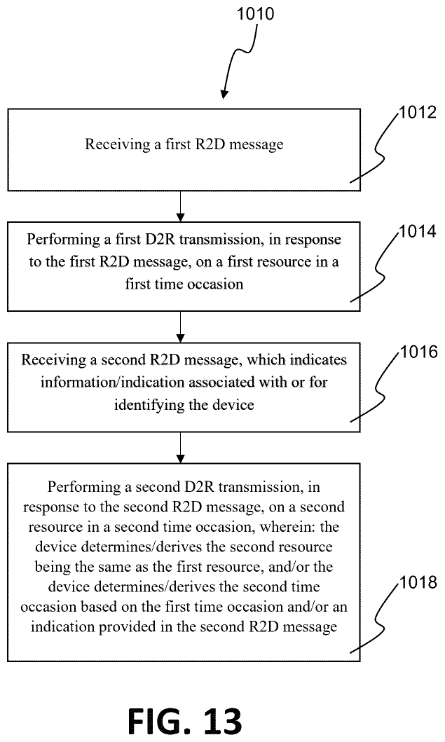

Referring to FIG. 13, with this and other concepts, systems, and methods of the present invention, a method 1010 for a device in a wireless communication system comprises receiving a first R2D message (step 1012), performing a first D2R transmission, in response to the first R2D message, on a first resource in a first time occasion (step 1014), receiving a second R2D message, which indicates information/indication associated with or for identifying the device (step 1016), and performing a second D2R transmission, in response to the second R2D message, on a second resource in a second time occasion, wherein: the device determines/derives the second resource being the same as the first resource, and/or the device determines/derives the second time occasion based on the first time occasion and/or an indication provided in the second R2D message (step 1018).

Referring back to FIGS. 3 and 4, in one or more embodiments from the perspective of a device in a wireless communication system, the device 300 includes a program code 312 stored in memory 310 of the transmitter. The CPU 308 could execute program code 312 to: (i) receive a first R2D message; (ii) perform a first D2R transmission, in response to the first R2D message, on a first resource in a first time occasion; (iii) receive a second R2D message, which indicates information/indication associated with or for identifying the device; and (iv) perform a second D2R transmission, in response to the second R2D message, on a second resource in a second time occasion, wherein: the device determines/derives the second resource being the same as the first resource, and/or the device determines/derives the second time occasion based on the first time occasion and/or an indication provided in the second R2D message. Moreover, the CPU 308 can execute the program code 312 to perform all of the described actions, steps, and methods described above, below, or otherwise herein.

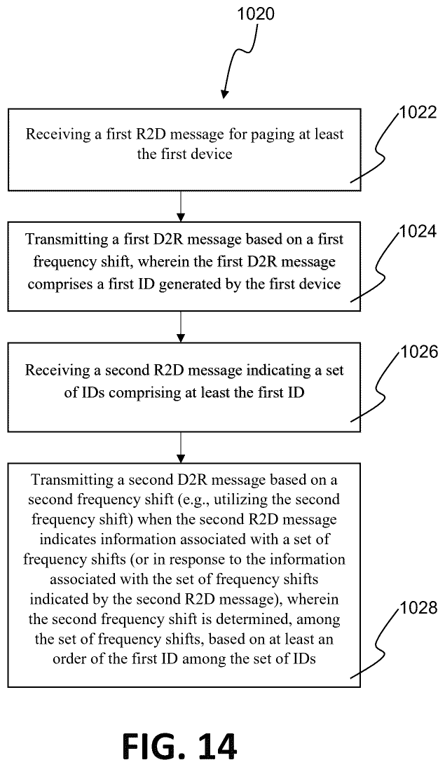

Referring to FIG. 14, with this and other concepts, systems, and methods of the present invention, a method 1020 for a first device in a wireless communication system comprises receiving a first R2D message for paging at least the first device (step 1022), transmitting a first D2R message based on a first frequency shift, wherein the first D2R message comprises a first ID generated by the first device (step 1024), receiving a second R2D message indicating a set of IDs comprising at least the first ID (step 1026), and transmitting a second D2R message based on a second frequency shift (e.g., utilizing the second frequency shift) when the second R2D message indicates information associated with a set of frequency shifts (or in response to the information associated with the set of frequency shifts indicated by the second R2D message), wherein the second frequency shift is determined, among the set of frequency shifts, based on at least an order of the first ID among the set of IDs (step 1028).

In various embodiments, an order of the second frequency shift among the set of frequency shifts is same as the order of the first ID among the set of IDs.

In various embodiments, the first frequency shift corresponds to a first frequency resource, the second frequency shift corresponds to a second frequency resource, and/or the set of frequency shifts corresponds to a set of frequency resources.

In various embodiments, the second R2D message indicates a set of frequency resources in one time occasion (i.e. the set of frequency resources fully overlapped in time domain), the second R2D message excludes or is not allowed to indicate resources for different (or multiple) time occasions (i.e. the resources not fully overlapped in time domain), the second R2D message schedules a set of D2R transmissions in the one time occasion (i.e. the set of D2R transmission fully overlapped in time domain), wherein the set of D2R transmissions are performed based on the set of frequency shifts, respectively, the second R2D message excludes or is not allowed to schedule D2R transmissions in different (or multiple) time occasions (i.e. the D2R transmission not fully overlapped in time domain), the first device performs a second D2R transmission, for transmitting the second D2R message, based on the second frequency shift in the one time occasion, or the one time occasion is derived or determined based on a (end of) reception time of an R2D transmission comprising the second R2D message.

In various embodiments, the first R2D message indicates one or more D2R resources in frequency domain and/or in time domain, the first device randomly selects a first D2R resource, among the one or more D2R resources, for performing a first D2R transmission for transmitting the first D2R message, and/or the first D2R resource corresponds to the first frequency shift.

In various embodiments, the first device transmits the first D2R message in response to (receiving) the first R2D message, and/or the first device transmits the first D2R message in response that the first R2D message pages the first device.

In various embodiments, the first device transmits the second D2R message in response to (receiving) the second R2D message.

In various embodiments, the first D2R message is a Msg1 or Msg.1. The first D2R message is or comprise a message of the first ID. The second R2D message is a Msg2, Msg.2, a response message of the first D2R message or a response message of the first ID. The second D2R message is a Msg3 or Msg.3. The second D2R message comprises a second ID of the first device.

In various embodiments, the first ID is a random ID generated by the first device.

In various embodiments, the first R2D message is or includes an Ambient IoT paging message for paging one or more Ambient IoT devices.

In various embodiments, the method further comprises transmitting the second D2R message based on the first frequency shift (e.g., utilizing the first frequency shift) when the second R2D message does not indicate the information associated with the set of frequency shifts.

In various embodiments, the set of frequency shifts is or comprises a set of allocated or scheduled frequency shifts, or the set of frequency shifts is allocated or scheduled for a set of D2R transmissions from one or more devices.

In various embodiments, the second R2D message not indicating the information associated with the set of frequency shifts comprises the second R2D message not providing information of allocated or scheduled frequency shifts.

Referring back to FIGS. 3 and 4, in one or more embodiments from the perspective of a first device in a wireless communication system, the device 300 includes a program code 312 stored in memory 310 of the transmitter. The CPU 308 could execute program code 312 to: (i) receive a first R2D message for paging at least the first device; (ii) transmit a first D2R message based on a first frequency shift, wherein the first D2R message comprises a first ID generated by the first device; (iii) receive a second R2D message indicating a set of IDs comprising at least the first ID; and (iv) transmit a second D2R message based on a second frequency shift when the second R2D message indicates information associated with a set of frequency shifts (or in response to the information associated with the set of frequency shifts indicated by the second R2D message), wherein the second frequency shift is determined, among the set of frequency shifts, based on at least an order of the first ID among the set of IDs. Moreover, the CPU 308 can execute the program code 312 to perform all of the described actions, steps, and methods described above, below, or otherwise herein.

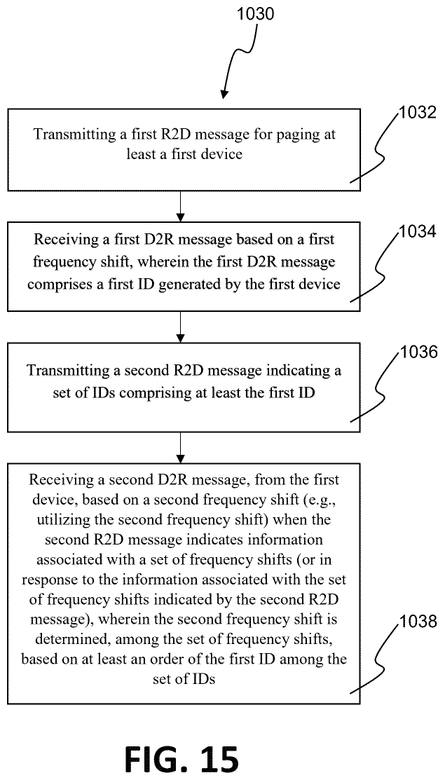

Referring to FIG. 15, with this and other concepts, systems, and methods of the present invention, a method 1030 for a reader in a wireless communication system comprises transmitting a first R2D message for paging at least a first device (step 1032), receiving a first D2R message based on a first frequency shift, wherein the first D2R message comprises a first ID generated by the first device (step 1034), transmitting a second R2D message indicating a set of IDs comprising at least the first ID (step 1036), and receiving a second D2R message, from the first device, based on a second frequency shift (e.g., utilizing the second frequency shift) when the second R2D message indicates information associated with a set of frequency shifts (or in response to the information associated with the set of frequency shifts indicated by the second R2D message), wherein the second frequency shift is determined, among the set of frequency shifts, based on at least an order of the first ID among the set of IDs (step 1038).

In various embodiments, an order of the second frequency shift among the set of frequency shifts is same as or identical to the order of the first ID among the set of IDs, the first frequency shift corresponds to a first frequency resource, the second frequency shift corresponds to a second frequency resource, and/or the set of frequency shifts corresponds to a set of frequency resources.

In various embodiments, the second R2D message indicates a set of frequency resources in one time occasion (i.e. the set of frequency resources fully overlapped in time domain), the second R2D message excludes or is not allowed to indicate resources for different (or multiple) time occasions (i.e. the resources not fully overlapped in time domain), the second R2D message schedules a set of D2R transmissions in the one time occasion (i.e. the set of D2R transmission fully overlapped in time domain), wherein the set of D2R transmissions are performed based on the set of frequency shifts, respectively, the second R2D message excludes or is not allowed to schedule D2R transmissions in different (or multiple) time occasions (i.e. the D2R transmission not fully overlapped in time domain), the reader (restricts to) transmits different second R2D messages to indicate resources for different (or multiple) time occasions, or the one time occasion is derived or determined based on a (end of) transmission time of an R2D transmission comprising the second R2D message.

In various embodiments, the first R2D message indicates one or more D2R resources in frequency domain and/or in time domain, the reader receives a first D2R transmission, comprising the first D2R message, on a first D2R resource among the one or more D2R resources, and/or the first D2R resource corresponds to the first frequency shift.

In various embodiments, the reader receives the first D2R message in response to (transmitting) the first R2D message, or the reader receives the second D2R message in response to (transmitting) the second R2D message.

In various embodiments, the first D2R message is a Msg1 or Msg.1. The first D2R message is or comprise a message of the first ID. The second R2D message is a Msg2, Msg.2, a response message of the first D2R message or a response message of the first ID. The second D2R message is a Msg3 or Msg.3. The second D2R message comprises a second ID of the first device.

In various embodiments, the first ID is a random ID generated by the first device.

In various embodiments, the method further comprises receiving the second D2R message based on the first frequency shift (e.g., utilizing the first frequency shift) when the second R2D message does not indicate the information associated with the set of frequency shifts.

In various embodiments, the set of frequency shifts is or comprises a set of allocated or scheduled frequency shifts, or the set of frequency shifts is allocated or scheduled for a set of D2R transmissions from one or more devices.

In various embodiments, the second R2D message not indicating the information associated with the set of frequency shifts comprises the second R2D message not providing information of allocated or scheduled frequency shifts.

Referring back to FIGS. 3 and 4, in one or more embodiments from the perspective of a reader in a wireless communication system, the device 300 includes a program code 312 stored in memory 310 of the transmitter. The CPU 308 could execute program code 312 to: (i) transmit a first R2D message for paging at least a first device; (ii) receive a first D2R message based on a first frequency shift, wherein the first D2R message comprises a first ID generated by the first device; (iii) transmit a second R2D message indicating a set of IDs comprising at least the first ID; and (iv) receive a second D2R message, from the first device, based on a second frequency shift when the second R2D message indicates information associated with a set of frequency shifts (or in response to the information associated with the set of frequency shifts indicated by the second R2D message), wherein the second frequency shift is determined, among the set of frequency shifts, based on at least an order of the first ID among the set of IDs. Moreover, the CPU 308 can execute the program code 312 to perform all of the described actions, steps, and methods described above, below, or otherwise herein.

Any combination of the above or herein concepts or teachings can be jointly combined, in whole or in part, or formed to a new embodiment. The disclosed details and embodiments can be used to solve at least (but not limited to) the issues mentioned above and herein.

It is noted that any of the methods, alternatives, steps, examples, and embodiments proposed herein may be applied independently, individually, and/or with multiple methods, alternatives, steps, examples, and embodiments combined together.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects, concurrent channels may be established based on pulse repetition frequencies. In some aspects, concurrent channels may be established based on pulse position or offsets. In some aspects, concurrent channels may be established based on time hopping sequences. In some aspects, concurrent channels may be established based on pulse repetition frequencies, pulse positions or offsets, and time hopping sequences.

Those of ordinary skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of ordinary skill in the art would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects, any suitable computer-program product may comprise a computer-readable medium comprising codes relating to one or more of the aspects of the disclosure. In some aspects, a computer program product may comprise packaging materials.

While the invention has been described in connection with various aspects and examples, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A method for a first device, comprising:
receiving a first Reader-to-Device (R2D) message for paging at least the first device;
transmitting a first Device-to-Reader (D2R) message based on a first frequency shift, wherein the first D2R message comprises a first Identification (ID) generated by the first device;
receiving a second R2D message indicating a set of IDs comprising at least the first ID; and
transmitting a second D2R message based on a second frequency shift when the second R2D message indicates information associated with a set of frequency shifts, wherein the second frequency shift is determined, among the set of frequency shifts, based on at least an order of the first ID among the set of IDs.

2. The method of claim 1, wherein an order of the second frequency shift among the set of frequency shifts is same as the order of the first ID among the set of IDs.

3. The method of claim 1, wherein:
the first frequency shift corresponds to a first frequency resource,
the second frequency shift corresponds to a second frequency resource, or
the set of frequency shifts corresponds to a set of frequency resources.

4. The method of claim 1, wherein:
the second R2D message indicates a set of frequency resources in one time occasion,
the second R2D message excludes or is not allowed to indicate resources for different time occasions,
the second R2D message schedules a set of D2R transmissions in the one time occasion, wherein the set of D2R transmissions are performed based on the set of frequency shifts, respectively,
the second R2D message excludes or is not allowed to schedule D2R transmissions in different time occasions,
the first device performs a second D2R transmission, for transmitting the second D2R message, based on the second frequency shift in the one time occasion, or
the one time occasion is derived or determined based on a reception time of an R2D transmission comprising the second R2D message.

5. The method of claim 1, wherein:
the first R2D message indicates one or more D2R resources in frequency domain and/or in time domain,
the first device randomly selects a first D2R resource, among the one or more D2R resources, for performing a first D2R transmission for transmitting the first D2R message, or
the first D2R resource corresponds to the first frequency shift.

6. The method of claim 1, wherein:
the first device transmits the first D2R message in response to the first R2D message, or
the first device transmits the second D2R message in response to the second R2D message.

7. The method of claim 1, wherein the first ID is a random ID generated by the first device.

8. The method of claim 1, wherein the first R2D message is or includes an Ambient Internet-of-Things (IoT) paging message for paging one or more Ambient IoT devices.

9. The method of claim 1, further comprising transmitting the second D2R message based on the first frequency shift when the second R2D message does not indicate the information associated with the set of frequency shifts.

10. The method of claim 1, wherein
the set of frequency shifts is or comprises a set of allocated or scheduled frequency shifts, or
the set of frequency shifts is allocated or scheduled for a set of D2R transmissions from one or more devices.

11. The method of claim 9, wherein the second R2D message not indicating the information associated with the set of frequency shifts comprises the second R2D message not providing information of allocated or scheduled frequency shifts.

12. A method for a reader, comprising:
transmitting a first Reader-to-Device (R2D) message for paging at least a first device;
receiving a first Device-to-Reader (D2R) message based on a first frequency shift, wherein the first D2R message comprises a first Identification (ID) generated by the first device;
transmitting a second R2D message indicating a set of IDs comprising at least the first ID; and
receiving a second D2R message, from the first device, based on a second frequency shift when the second R2D message indicates information associated with a set of frequency shifts, wherein the second frequency shift is determined, among the set of frequency shifts, based on at least an order of the first ID among the set of IDs.

13. The method of claim 12, wherein:
an order of the second frequency shift among the set of frequency shifts is same as or identical to the order of the first ID among the set of IDs,
the first frequency shift corresponds to a first frequency resource,
the second frequency shift corresponds to a second frequency resource, or
the set of frequency shifts corresponds to a set of frequency resources.

14. The method of claim 12, wherein:
the second R2D message indicates a set of frequency resources in one time occasion,
the second R2D message excludes or is not allowed to indicate resources for different time occasions,
the second R2D message schedules a set of D2R transmissions in the one time occasion, wherein the set of D2R transmissions are performed based on the set of frequency shifts, respectively,
the second R2D message excludes or is not allowed to schedule D2R transmissions in different time occasions,
the reader transmits different second R2D messages to indicate resources for different time occasions, or
the one time occasion is derived or determined based on a transmission time of an R2D transmission comprising the second R2D message.

15. The method of claim 12, wherein:
the first R2D message indicates one or more D2R resources in frequency domain and/or in time domain,
the reader receives a first D2R transmission, comprising the first D2R message, on a first D2R resource among the one or more D2R resources, or
the first D2R resource corresponds to the first frequency shift.

16. The method of claim 12, wherein:
the reader receives the first D2R message in response to the first R2D message, or
the reader receives the second D2R message in response to the second R2D message.

17. The method of claim 12, wherein the first ID is a random ID generated by the first device.

18. The method of claim 12, further comprising receiving the second D2R message based on the first frequency shift when the second R2D message does not indicate the information associated with the set of frequency shifts.

19. The method of claim 12, wherein
the set of frequency shifts is or comprises a set of allocated or scheduled frequency shifts, or
the set of frequency shifts is allocated or scheduled for a set of D2R transmissions from one or more devices.

20. The method of claim 18, wherein the second R2D message not indicating the information associated with the set of frequency shifts comprises the second R2D message not providing information of allocated or scheduled frequency shifts.
